(19) United States
(12) Patent Application Publication
(10) Pub. No.: US 2026/0049517 A1
(43) Pub. Date: Feb. 19, 2026

(54) MULL SEALING CAP FOR WINDOWS AND DOORS

(71) Applicant: MI Windows and Doors, LLC, Harrisburg, PA (US)

(72) Inventors: Stephany Moore, Shoreline, WA (US); Troy Kunkel, Olympia, WA (US)

(21) Appl. No.: 19/303,232

(22) Filed: Aug. 18, 2025

Related U.S. Application Data
(60) Provisional application No. 63/684,335, filed on Aug. 16, 2024.

(51) Int. Cl. E06B 1/36

(52) U.S. Cl. CPC E06B 1/366

(57) ABSTRACT

A system for mulling a first fenestration frame and a second fenestration frame together, including a first fenestration frame having a first jamb and a second jamb; a second fenestration frame having a first jamb and a second jamb; a mull connector securing the first fenestration frame and the second fenestration frame together, and an end cap including a body operatively secured to a first end of the mull connector and including a channel extending about a front portion of the body of the end cap.

### BACKGROUND OF THE INVENTION

### Field of the Invention

The present invention relates generally to fenestration assemblies and in particular to a system and method for mulling of windows and doors.

### Description of Related Art

Window and door units are sometimes grouped together and installed into one opening in the building that must first be connected together and sealed. This connection of units is called mulling. Units can be mulled in the factory (factory mulled) or on the jobsite prior to installation (field mulled). Factory mulled windows are typically preferred. Field mulling is used when factory mulling cannot be performed due to size, weight or shipping limits. Field mulling adds labor and complexity because the installer must assemble and seal the unit prior to installation. Once mulled on the jobsite the oversized units must be lifted into the opening which risks injury to the installers as well as damage to the mulled unit.

It would be desirable to provide a system and method for both factory mulling and field mulling two or more fenestration assemblies (e.g., windows and/or doors) that allows each fenestration assembly to be installed in an opening of a building one at a time or together and providing a seal between the mulled fenestration assemblies.

### SUMMARY OF THE INVENTION

In view of the foregoing, it is an object of the present disclosure to provide a system, a mulled fenestration assembly, and a method.

In some aspects, the techniques described herein relate to a system for mulling a first fenestration frame and a second fenestration frame together, the system including: a first fenestration frame having a first jamb and a second jamb; a second fenestration frame having a having a first jamb and a second jamb; a mull connector securing the first fenestration frame and the second fenestration frame together; and an end cap including a body operatively secured to a first end of the mull connector and including a channel extending about a front portion of the body of the end cap.

In some aspects, the techniques described herein relate to a mulled fenestration assembly: a first fenestration frame having a first fenestration frame member; a second fenestration frame having a second fenestration frame member facing the first fenestration frame member; and a mull connector having a first engagement member with a beveled terminal portion guiding the first engagement member onto a flange of the first frame member and a second engagement member with a beveled terminal end guiding the second engagement member onto a second flange of the second frame member.

In some aspects, the techniques described herein relate to a method of sealing an end cap on a mulled fenestration assembly including: providing a first fenestration frame; providing a second fenestration frame; securing a mull connector having a first end and a second end to the first fenestration frame and a second fenestration frame; securing a first end cap to the first end of the mull connector and a second end cap to the second end connector, wherein the end cap includes an aperture in fluid communication with a channel extending about a front portion of the end cap; and applying sealant to the end cap through the aperture until the channel is completely filled with sealant.

The following will describe embodiments of the present disclosure, but it should be appreciated that the present disclosure is not limited to the described embodiments and various modifications of the invention are possible without departing from the basic principle. The scope of the present disclosure is therefore to be determined solely by the appended claims.

### BRIEF DESCRIPTION OF THE SEVERAL VIEWS OF THE DRAWINGS

FIG. 1 is an exploded perspective view of a fenestration assembly.

FIG. 2 is a cross sectional view of a primary mull connector engaged with the first and second fenestration assembly of FIG. 1.

FIG. 3 is a cross sectional view of a primary mull connector, second mull connector secured to the first and second fenestration assembly of FIG. 1 and the primary mull connector.

FIG. 4 is a close-up view of the primary mull connector engagement tabs engaged with the first and second fenestration assembly of FIG. 1.

FIG. 5 is a perspective view of an end cap.

FIG. 6 is a top view of the end cap of FIG. 5.

FIG. 7 is a bottom view of the end cap of FIG. 5.

FIG. 8 is a side view of the end cap of FIG. 5.

FIG. 9 is a partial cross-sectional view of the end cap secured to the primary mull connector, pad, and accessory sealing member of FIG. 1.

FIG. 10 is a close-up view of an engagement portion of taken generally about line 10-10 in FIG. 4.

FIG. 11 is a plan view of the fenestration assembly with a visible indication of sealant applied to the channel of the end cap.

### DETAILED DESCRIPTION OF THE INVENTION

The following description discusses a system and method for mulling two or more fenestration assemblies (e.g., windows and/or doors). While the following description refers to windows, it should be understood that the systems and methods described herein may also be used with other types of fenestration assemblies (e.g., doors). For the purposes of this application, the term “exterior” will refer to the direction toward the outside of an enclosure or building while the term “interior” will refer to the direction toward the inside of the enclosure or building.

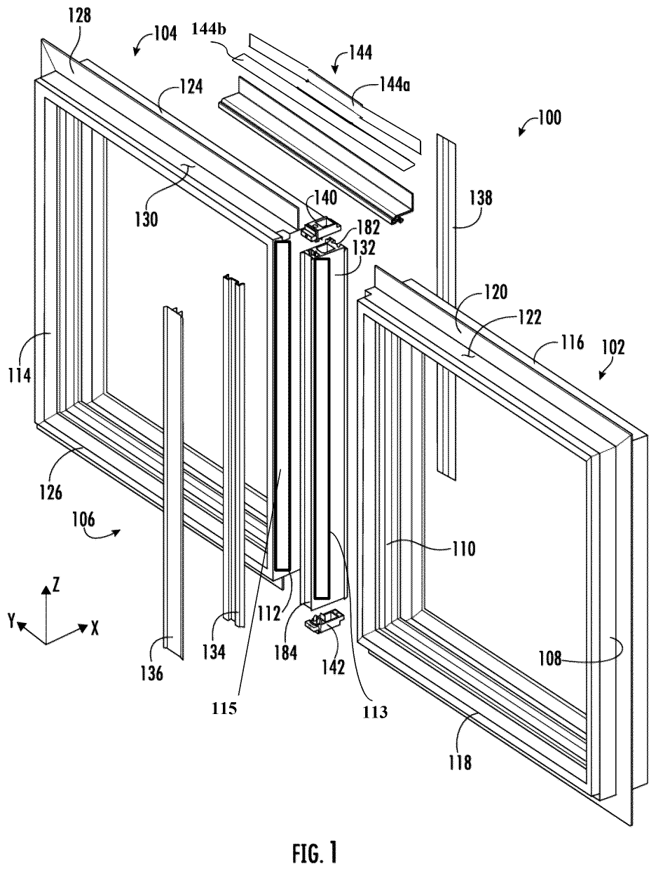

Referring to FIG. 1 a mulled fenestration assembly 100 includes a first fenestration frame 102 and a second fenestration frame 104 being secured together with a mull assembly 106. First fenestration frame 102 includes a first frame member 108 and a second frame member 110 spaced from and parallel to first frame member 108 of first fenestration frame 102. Second fenestration frame 104 includes a first frame member 112 and a second fenestration second frame member 114 spaced from and parallel to first frame member 112. Second frame member 110 of first fenestration frame 102 is closely adjacent to first frame member 112 of second fenestration frame 104 when first fenestration frame 102 and second fenestration frame 104 are secured to one another with mull assembly 106. First fenestration frame 102 includes a third frame member 116 and a fourth frame member 118 spaced from and parallel to third frame member 116. Third frame member 116 includes a nail flange 120 extending therefrom and a planar surface 122. Similarly, second fenestration frame 104 includes a third frame member 124 and a fourth frame member 126 spaced from and parallel to third frame member 124. Third frame member 124 includes a nail flange 128 and a planar surface 130. First frame member 112 includes a foam strip 115 (shown in FIGS. 1-3) located on its exterior surface facing primary mull connector 132. Foam strip 115 extends along the long axis of first frame member 112 from adjacent the location that first frame member 112 intersects third frame member 124 to adjacent the location that first frame member 112 intersects fourth frame member 126. Second frame member 110 includes a foam strip 113 (shown in FIGS. 1-3) located on its exterior surface facing primary mull connector 132. Foam strip 113 extends along the long axis of second frame member 110 from adjacent the two ends of second frame member 110. Foam strips 115, 113 are attached to the first frame 112 and second frame member 110, respectively by an adhesive located on the foam strips 115, 113. It should be appreciated that embodiments include foam strips 113, 115 not being affixed to the first frame 112 and the second frame member 110 by an adhesive, but simply located between first frame 112 and primary mull connector 132 or second frame member 110 and primary mull connector 132 by a friction fit.

Mull assembly 106 includes a primary mull connector 132, a secondary mull connector 134, a first cover 136, a second cover 138, a first end cap 140 and a second end cap 142. As discussed below a pad 144 includes a first portion 144a that is positioned adjacent nail flange 120 and nail flange 128 and a second portion 144b adjacent planar surface 122, nail flange 128 and first end cap 140. First portion 144a and second portion 144b are separate strips. In one implementation pad 144 is coextensive with (i.e., the same length as) sealing cover 145. Sealing cover 145 does not extend the entire length of planar surface 122 of third frame member 116 of first fenestration frame 102 or the entire length of planar surface 130 of third frame member 124 of second fenestration frame. Rather, pad 144 and sealing cover 145 will extend a predetermined length along planar surfaces 122 and 130. In one embodiment, the predetermined length is between 7-10 inches on both the planar surfaces 122 and 130. In another embodiment, the predetermined length is between 8-9 inches on both the planar surfaces 122 and 130. As discussed herein below pad 144 is positioned between sealing cover 145 and first fenestration frame 102 and second fenestration frame 104.

FIG. 1 illustrates a coordinate system used to facilitate the description herein. In the coordinate system, the X-axis represents the direction perpendicular to the plane of the fenestrations. Thus, for a fenestration assembly on a wall of a building, the positive X-axis is directed from the exterior of the building toward the interior of the building. The positive Y-axis is directed in the plane of the fenestrations in a direction from one fenestration frame to the next. In one implementation first fenestration frame 102 and second fenestration frame 104 are secured together with mull assembly 106 in a horizontal orientation such that a longitudinal axis of primary mull connector 132 extends in a direction of gravity when installed on a structure on earth. Stated another way the longitudinal axis of primary mull connector 132 extends along or parallel to the Z-axis. However, first fenestration frame 102 and second fenestration frame 104 can also be secured together with mull assembly 106 in a vertical orientation such that the longitudinal axis of primary mull connector 132 is perpendicular to the direction of gravity when the mulled frames or installed on a structure on earth. The term above and below as used herein describe the relative position of components in relation to the orientation of the components illustrated in the Figures.

The term jamb as used herein shall be used interchangeably with first frame member 108, second frame member 110, first frame member 112 and second fenestration second frame member 114. However, while the term jamb is often referred to as the portions of a rectangular or square fenestration that extend parallel to the direction of gravity, the term jamb as used herein may also mean the portions of the frames that extend perpendicular to the direction of gravity.

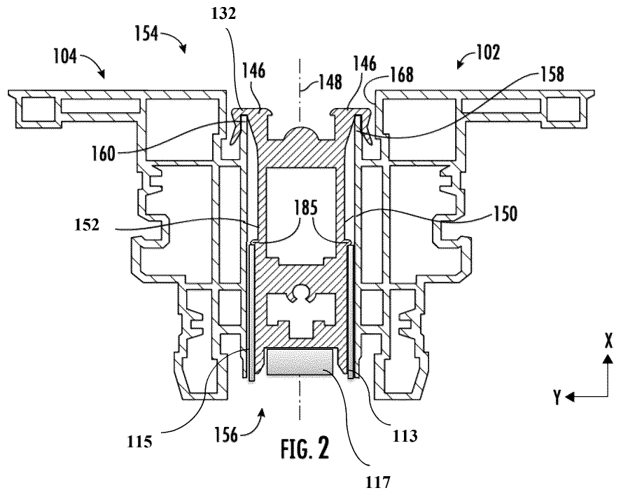

Referring to FIG. 2, primary mull connector 132 is secured to first fenestration frame 102 and second fenestration frame 104 with a pair of engagement members 146 that are a mirror image of one another taken along a cross-direction axis 148, primary mull connector 132 includes a first wall member 150 and a second wall member 152 spaced from and generally parallel to first wall member 150. Primary mull connector 132 is slid between first fenestration frame 102 and second fenestration frame 104 in the cross fenestration direction from a first side 154 of first fenestration frame 102 and second fenestration frame 104 toward the second opposing side 156 of first fenestration frame 102 and second fenestration assembly 100 and frame 104. In one implementation first side 154 is the interior side of the fenestration and second opposing side 156 is the exterior side of mull assembly 106. Engagement members 146 engage a portion of a leg 158 of first fenestration frame 102 and a leg 160 of second fenestration frame 104.

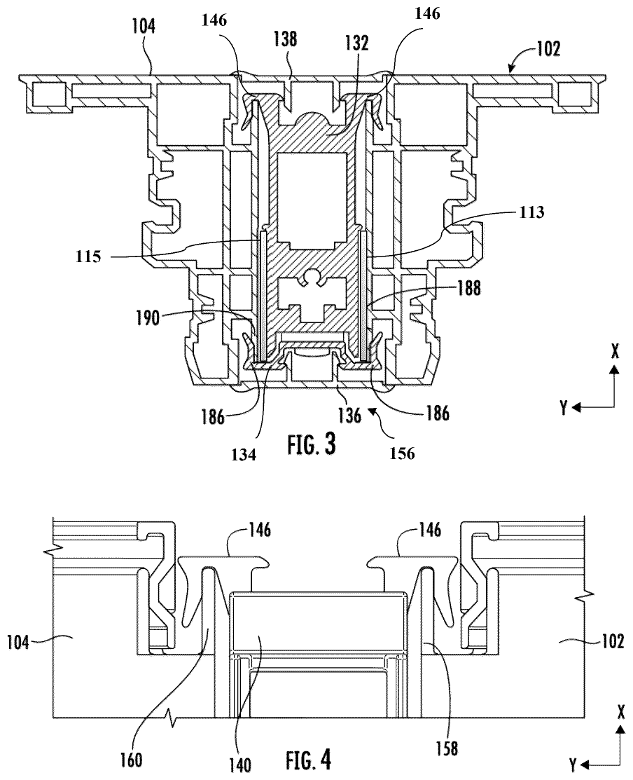

Referring to FIG. 4 and FIG. 10 engagement member 146 includes an extension member 162 that extends from a body 164 of primary mull connector 132 by a portion 166. Portion 166 extends away from body 164 in a direction perpendicular to and away from cross-direction axis 148. Extension member 162 extends generally in a direction parallel to cross-direction axis 148. Extension member 162 includes a first extending portion 168 that is positioned furthest from cross-direction axis 148 and is adjacent to a surface 171 of second frame member 110 spaced from leg 158. Extension member 162 includes a first portion 170 having a first side 172 that is parallel to cross-direction axis 148 and a second portion 174 that extends in a direction outward from cross-direction axis 148 forming a beveled surface 176. Second side linear of first portion 170 and second portion 174 forms a concave surface extending from body 164 portion concave portion 178. In one implementation second portion 174 extends from first side 172 of first portion 170 at an angle 180 between fifteen and forty degrees. In one implementation angle 180 is 25 degrees.

In practice second frame member 110 of 102 and/or first frame member 112 of second fenestration frame 104 may warp or bend from the ideal design. Stated another way leg 158 and or leg 160 may not form a straight line from a first end 182 of primary mull connector 132 to a second opposing end 184 of primary mull connector 132. Accordingly, when this occurs engagement members 146 have a difficult time fitting onto leg 158 and leg 160 as primary mull connector 132 is slid between first fenestration frame 102 and second fenestration frame 104. The beveled second portion 174 allows primary mull connector 132 to properly engage the entire length of leg 158 and leg 160 as primary mull connector 132 secures first fenestration frame 102 and second fenestration frame 104 together.

Referring to FIG. 2, body 164 of primary mull connector 132 includes a pair of supports 185 that assists in minimizing deflection of second frame member 110 of first fenestration frame 102 and first frame member 112 of second fenestration frame 104 when first fenestration frame 102 and second fenestration frame 104 are mulled together.

Referring to FIG. 2 primary mull connector 132 is secured to first fenestration frame 102 and second fenestration frame 104 free of any secondary separate fasteners such as a screw. Referring to FIG. 3, once primary mull connector 132 is secured to first fenestration frame 102 and second fenestration frame 104 through engagement members 146 secondary mull connector 134 is secured to first fenestration frame 102 and second fenestration frame 104 with engagement members 186 to flange 188 and flange 190 positioned on of the second opposing side 156 of first fenestration frame 102 and second fenestration frame 104 respectively. Engagement members 186 are secured over 188 and flange 190 in the same manner as engagement members 146 are positioned over leg 158 and leg 160. A fastener or plurality of fasteners secure secondary mull connector 134 to primary mull connector 132. In this manner no separate fasteners connect either primary mull connector 132 and secondary mull connector 134 directly to first fenestration frame 102 and second fenestration frame 104.

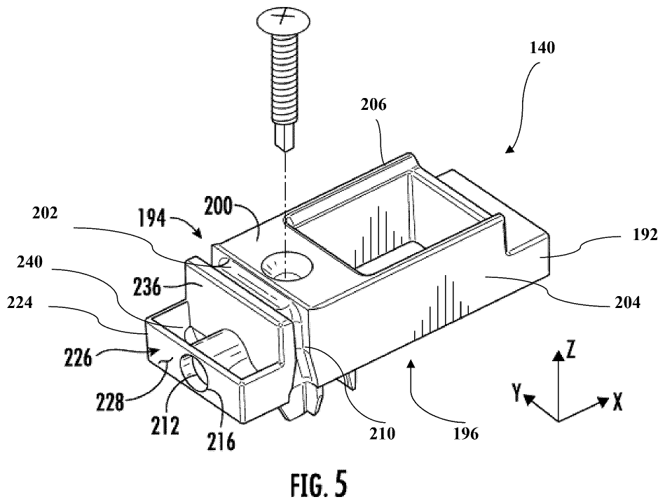

Referring to FIGS. 5-9 end cap 140 includes a body 192 operatively secured to first end 182 primary mull connector 132 and includes a channel 194 extending circumferentially about end cap 140. The first side 196 having a first channel portion 198 of channel 194. Channel 194 includes a second side 200 (top) extending opposite the first side 196 and facing away from primary mull connector 132 when the end cap 140 is secured to primary mull connector 132. Second side 200 includes a second channel portion 202 of channel 194. Body 192 includes a third side 204 (left) and an opposing fourth side 206 (right) extending between the first side 196 and the second side 200. The third side 204 having a third channel portion 208. Third side 204 and opposing fourth side 206 are spaced from one another and each defining a plane substantially parallel to one another. The fourth side 206 (right) extending between the first side 196 and the second side 200, the fourth side having a fourth channel portion 210 of body 192.

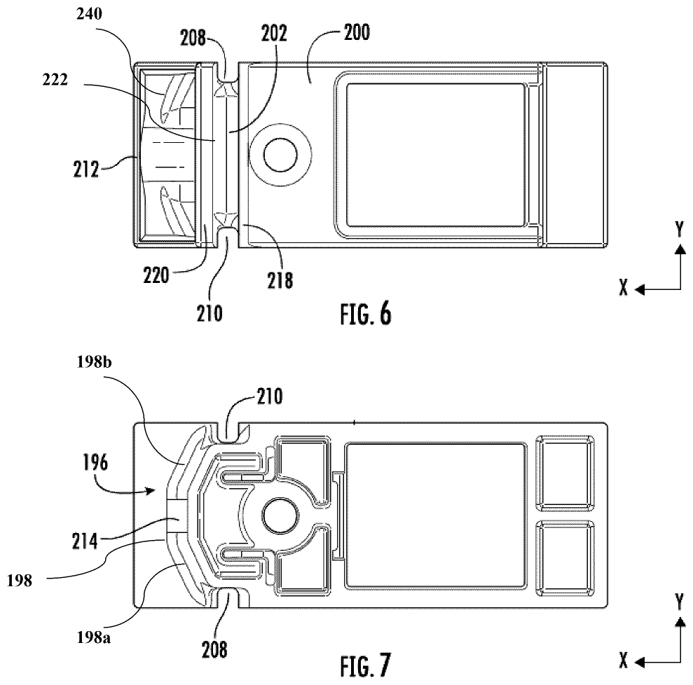

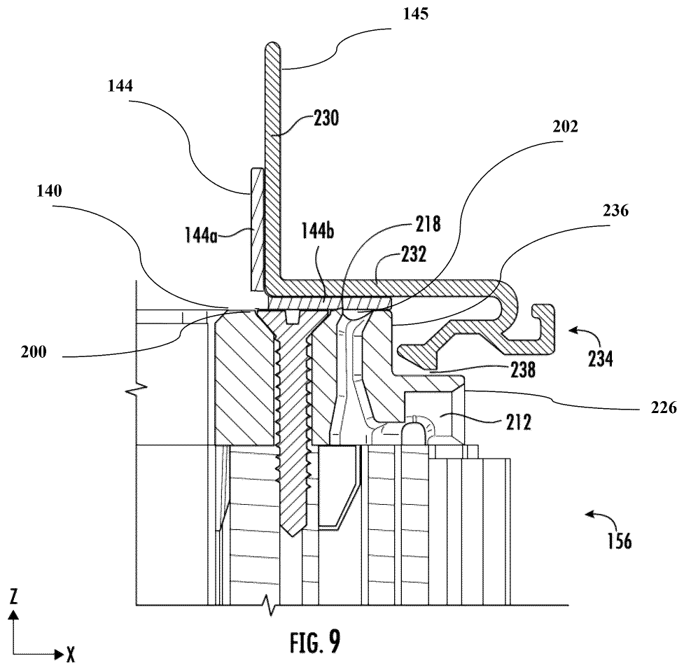

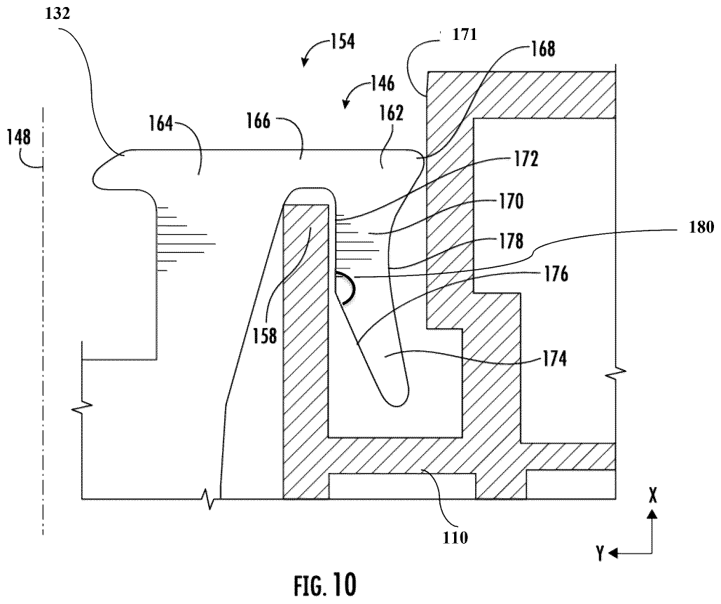

Referring to FIG. 5 and FIG. 9 end cap 140 includes an aperture 212 extending into the body 192 and being in in fluid communication with channel 194. Referring to FIG. 7 aperture 212 has an exit 214 spaced from aperture opening 216. Exit 214 is in fluid communication with first channel portion 198. First channel portion 198 includes a first branch 198a in fluid communication with third channel portion 208 and a second branch 198b in fluid communication with fourth channel portion 210. Referring to FIG. 6, third channel portion 208 and fourth channel portion 210 are in fluid communication with second channel portion 202. Aperture 212 acts as a receptacle or conduit to receive a nozzle to inject sealant into channel 194 to form a continuous weathertight seal about the entire periphery about end cap 140.

Referring to FIG. 9 and FIG. 10 once primary mull connector 132, secondary mull connector 134 and end cap 140 are secured to first fenestration frame 102 and second fenestration frame 104, pad 144 is placed on sealing cover 145 and then pad 144 with the sealing cover 145 is place on the second side 200 (top) of end cap 140 such that it covers nail flanges 120, 128 and planar surfaces 120, 130. First portion 144b of pad 144 extends over second side 200, planar surface 122 of third frame member 116 of first fenestration frame 102 and, planer surface 130 of third frame member 124 of second fenestration frame 104. Additionally, second portion 144a of pad 144 extends over nail flange 120 of first fenestration frame 102 and nail flange 128 of second fenestration frame 104. In one implementation pad 144 is placed on nail flange 120 and nail flange 128 with an adhesive. In one implementation pad 144 is placed on planar surface 122 and planar surface 130 without an adhesive. Referring to FIG. 9, pad 144 covers the opening of second channel portion 202.

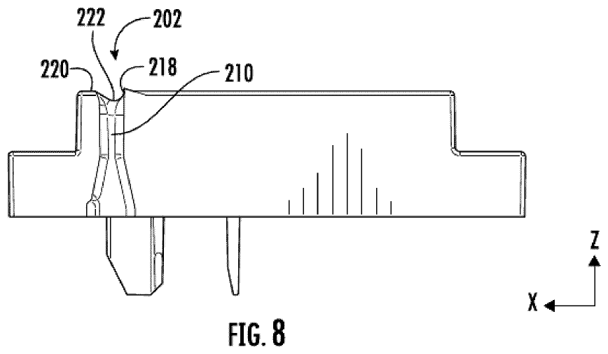

Referring to FIG. 6 and FIG. 8 the second channel portion 202 includes a first upper edge 218 and a second upper edge 220, the first upper edge 218 extends a first distance from a bottom 222 of the second channel portion 202, and the second upper edge 220 extends a second distance from the bottom 222 of the second channel portion 202 that is less than the first distance. First upper edge 218 has a pointed tip that protrudes into pad 144. Stated another way first upper edge 218 extends above a plane generally defined by the surface defining second side 200. In a non-directional description, first upper edge 218 has a distance from first side 196 that is greater than the rest of second side 200.

For end cap 140, third side 204 is adjacent a surface of second frame member 110 of first fenestration frame 102 and opposing fourth side 206 is adjacent a surface of first frame member 112 of first fenestration frame 104. First side 196 of end cap 140 is adjacent a first end 182 of primary mull connector 132. Second frame member 110 of first fenestration frame 102, first frame member 112 of second fenestration frame 104, first end 182 of primary mull connector 132, pad 144, and body 192 of end cap 140 define a closed passageway in channel 194.

Referring to FIG. 5 a fifth side 224 of the end cap 140 includes a first nose portion 226 having a surface 228 perpendicular to first side 196, second side 200, third side 204 and fourth side 206. Aperture opening 216 extends through surface 228. Extending from nose portion 226 is a wall portion 236 that is generally parallel to a plane defined by a glazing within the first fenestration frame 102 and the glazing with second fenestration frame 104.

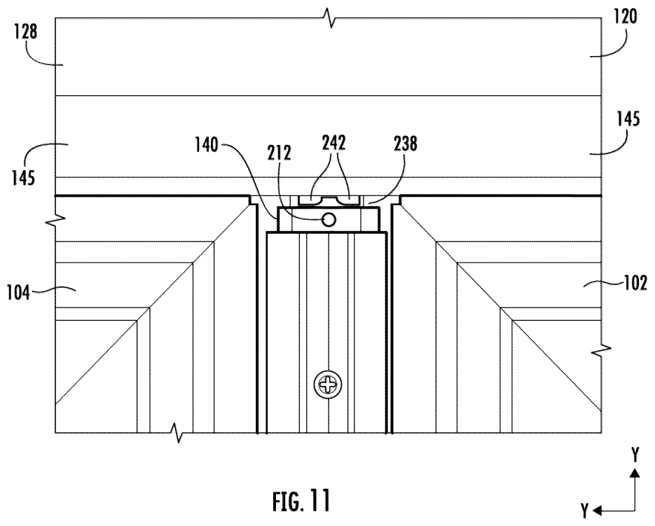

Referring to FIG. 9 and FIG. 11, sealing cover 145 has a first portion 230 adjacent first portion 144a of pad 144 adjacent nail flange and nail flange 128, and a second portion 232 adjacent second portion 144b of pad 144 over second side 200 of end cap 140 and a third portion 234 that extends below second side 200 and over first nose portion 226 and being spaced from wall portion 236 such that there is a gap 238 between third portion 234 and nose portion 226. As a sealant is applied to aperture 212 the sealant extends into exit 214 and then into first branch 198a and second branch 198b of first channel portion 198 and then into third channel portion 208 and fourth channel portion 210 and then into second channel portion 202. Once channel 194 is completely full of sealant any additional sealant introduced into channel 194 through aperture 212 causes sealant in second channel portion 202 to compress second portion 144b of pad 144 and overflow along wall portion 236 and enter into a cavity 240 in first nose portion 226. A portion of the excess sealant 242 is visible to a user below third portion 234 of sealing cover 145 above aperture 212 providing a visual indication that channel 194 is full of sealant and that there is a weather tight seal about end cap 140 between primary mull connector 132, first fenestration frame 102, second fenestration frame 104 and pad 144. First upper edge 218 that digs into second portion 144b of pad 144 prevents sealant from flowing toward first portion 144a and causes all excess sealant to flow toward gap 238 and cavity 240 along wall portion 236.

In one implementation First end cap 140 and second end cap 142 are identical. Second end cap 142 is secured to second end 184 of primary mull connector 132 in the same manner as end cap 140 is secured to first end 182 of primary mull connector 132. Both end cap 140 and second end cap 142 provide a weather tight seal between first fenestration frame 102 and second fenestration frame 104 by the application of an sealant in channel 194 between the exterior side of mulled fenestration assembly 100 and the interior side of mulled fenestration assembly 100.

Provided below are various implementations of the mull system.
Implementation 1. A system for mulling a first fenestration frame and a second fenestration frame together, the system comprising: a first fenestration frame having a first jamb and a second jamb; a second fenestration frame having a first jamb and a second jamb; a mull connector securing the first fenestration frame and the second fenestration frame together; and an end cap including a body operatively secured to a first end of the mull connector and including a channel extending about a front portion of the body of the end cap.
Implementation 2. The system of implementation 1, wherein the end cap includes an aperture extending into the end cap and being in in fluid communication with the channel.
Implementation 3. The system of implementation 2, wherein the end cap includes: a first side positioned adjacent a first end of the mull connector, the first side having a first channel portion of the channel, a second side extending opposite the first side and facing away from the mull connector, the second side having a second channel portion; a third side and an opposing fourth side extending between the first side and the second side, the third side having a third channel portion; a fourth side extending between the first side and the second side and generally perpendicular to the first side and second side, the fourth side having a fourth channel portion; and the aperture being in fluid communication with the first channel portion that is in fluid communication with the third channel portion and the fourth channel portion, the third channel portion and the fourth channel portion being in fluid communication with the second channel portion.
Implementation 4. The system of implementation 3 wherein the first channel includes a first branch in fluid communication with the third channel portion and a second branch in fluid communication with the fourth channel portion.
Implementation 5. The system of implementation 4, wherein the first branch and the second branch of the first channel portion extend from the aperture in non-colinear directions.
Implementation 6. The system of implementation 5, wherein the second channel includes a first upper edge and a second upper edge, the first upper edge extending a first distance from a bottom of the second channel portion, and the second upper edge extending a second distance from the bottom of the second channel portion that is less than the first distance.
Implementation 7. The system of implementation 3, wherein the aperture extends into a fifth side of the end cap that is generally perpendicular to the first side, second side, third side and fourth side of the end cap; and a sealant extending through in the aperture and channel and including a portion exiting the channel distal to the aperture providing a visual indication on the fifth side that the channel is completely full of sealant.
Implementation 8. The system of implementation 7, further including a sealing cover extending over a portion of the second side of the end cap and over a portion of the fifth side of the end cap, wherein the portion of the sealant that provides the visual indication extends between the aperture and the sealing cover.
Implementation 9. The system of implementation 8, further including a pad extending over the second portion of the channel between the sealing cover and the second side of the end cap, wherein a portion of the sealant compresses a portion of the pad and provides the visual indication.
Implementation 10. The system of implementation 9, wherein the fifth side of the end cap includes a first nose portion including the aperture and a recessed second portion between the nose portion and the second side, a sealing cover being position over and spaced from the recessed second portion, the portion of sealant extending from the second channel portion and between the recessed portion of the fifth side and the nose portion.
Implementation 11. The system of implementation 1, wherein the mull connector includes a center mull that is secured to the first frame and the second frame free of any separate fasteners and a second mull connector operative secured to the first and second frame free of any separate fasteners, the second mull connector being secured to the center mull with at least one separate fastener.
Implementation 12. The system of implementation 1, wherein the first frame and the second frame each include a nail flange, a pad being positioned over the end cap, wherein the second end of the mull connector has a planar surface with protrusions adjacent to the second jamb of the first fenestration frame and to the first jamb of the second fenestration frame.
Implementation 13. The system of implementation 1, wherein the second jamb of the first fenestration frame and the first jamb of the second fenestration frame include a first frame member and a second frame member facing each other, and the mull connector includes a raised portion to prevent the first frame member and the second frame member from bending.
Implementation 14. The system of implementation 1, further including a sealant sealing an exterior portion of the mull connector with second jamb of the first fenestration frame and with the first jamb of the second fenestration frame.
Implementation 15. The system of implementation 1, wherein the mull connector includes a first pair of engagement members, each engagement member having a beveled terminal portion assisting in guiding the engagement members to engage with a corresponding leg on the first fenestration frame and on the second fenestration frame.
Implementation 16. A mulled fenestration assembly: a first fenestration frame having a first fenestration frame member; a second fenestration frame having a second fenestration frame member facing the first fenestration frame member; and a mull connector having a first engagement member with a beveled terminal portion guiding the first engagement member onto a flange of the first frame member and a second engagement member with a beveled terminal end guiding the second engagement member onto a second flange of the second frame member.
Implementation 17. The mulled fenestration assembly of implementation 16, further including an end cap including a body operatively secured to a first end of the mull connector and including a channel extending about a front portion of the body of the end cap.
Implementation 18. The mulled fenestration assembly of implementation 17, wherein the end cap includes an aperture extending into the end cap and being in in fluid communication with the channel.
Implementation 19. A method of sealing an end cap on a mulled fenestration assembly comprising: providing a first fenestration frame; providing a second fenestration frame; securing a mull connector having a first end and a second end to the first fenestration frame and a second fenestration frame; securing a first end cap to the first end of the mull connector and a second end cap to the second end connector, wherein the end cap includes an aperture in fluid communication with a channel extending about a front portion of the end cap; and applying sealant to the end cap through the aperture until the channel is completely filled with sealant.
Implementation 20. The method of implementation 19, further including providing a sealing cover over the end cap prior to applying sealant to the end cap and continuing to apply sealant to the end cap until sealant is visible between the aperture and the sealing cover.

It is important to note that the construction and arrangement of system for mulling a plurality of fenestration assemblies as described herein is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements and vice versa, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the exemplary embodiments without departing from the scope of the present inventions as expressed in the appended claims.

What is claimed is:

1. A system for mulling a first fenestration frame and a second fenestration frame together, the system comprising:
a first fenestration frame having a first jamb and a second jamb;
a second fenestration frame having a having a first jamb and a second jamb;
a mull connector securing the first fenestration frame and the second fenestration frame together; and
an end cap including a body operatively secured to a first end of the mull connector and including a channel extending about a front portion of the body of the end cap.

2. The system of claim 1, wherein the end cap includes an aperture extending into the end cap and being in in fluid communication with the channel.

3. The system of claim 2, wherein the end cap includes:
a first side positioned adjacent a first end of the mull connector, the first side having a first channel portion of the channel,
a second side extending opposite the first side and facing away from the mull connector, the second side having a second channel portion;
a third side and an opposing fourth side extending between the first side and the second side, the third side having a third channel portion;
a fourth side extending between the first side and the second side and generally perpendicular to the first side and second side, the fourth side having a fourth channel portion; and
the aperture being in fluid communication with the first channel portion that is in fluid communication with the third channel portion and the fourth channel portion, the third channel portion and the fourth channel portion being in fluid communication with the second channel portion.

4. The system of claim 3 wherein the first channel includes a first branch in fluid communication with the third channel portion and a second branch in fluid communication with the fourth channel portion.

5. The system of claim 4, wherein the first branch and the second branch of the first channel portion extend from the aperture in non-colinear directions.

6. The system of claim 5, wherein the second channel includes a first upper edge and a second upper edge, the first upper edge extending a first distance from a bottom of the second channel portion, and the second upper edge extending a second distance from the bottom of the second channel portion that is less than the first distance.

7. The system of claim 3, wherein the aperture extends into a fifth side of the end cap that is generally perpendicular to the first side, second side, third side and fourth side of the end cap; and a sealant extending through in the aperture and channel and including a portion exiting the channel distal to the aperture providing a visual indication on the fifth side that the channel is completely full of sealant.

8. The system of claim 7, further including a sealing cover extending over a portion of the second side of the end cap and over a portion of the fifth side of the end cap, wherein the portion of the sealant that provides the visual indication extends between the aperture and the sealing cover.

9. The system of claim 8, further including a pad extending over the second portion of the channel between the sealing cover and the second side of the end cap, wherein a portion of the sealant compresses a portion of the pad and provides the visual indication.

10. The system of claim 9, wherein the fifth side of the end cap includes a first nose portion including the aperture and a recessed second portion between the nose portion and the second side, a sealing cover being position over and spaced from the recessed second portion, the portion of sealant extending from the second channel portion and between the recessed portion of the fifth side and the nose portion.

11. The system of claim 1, wherein the mull connector includes a center mull that is secured to the first frame and the second frame free of any separate fasteners and a second mull connector operative secured to the first and second frame free of any separate fasteners, the second mull connector being secured to the center mull with at least one separate fastener.

12. The system of claim 1, wherein the first frame and the second frame each include a nail flange, a pad being positioned over the end cap and a sealing includes the second end of the mull connector has a planar surface with protrusions adjacent to the second jamb of the first fenestration frame and to the first jamb of the second fenestration frame.

13. The system of claim 1, wherein the second jamb of the first fenestration frame and the first jamb of the second fenestration frame include a first frame member and a second frame member facing each other, and the mull connector includes a raised portion to prevent the first frame member and the second frame member from bending.

14. The system of claim 1, further including a sealant sealing an exterior portion of the mull connector with second jamb of the first fenestration frame and with the first jamb of the second fenestration frame.

15. The system of claim 1, wherein the mull connector includes a first pair of engagement members, each engagement member having a beveled terminal portion assisting in guiding the engagement members to engage with a corresponding a flange on the first fenestration frame and on the second fenestration frame.

16. A mulled fenestration assembly:
a first fenestration frame having a first fenestration frame member;
a second fenestration frame having a second fenestration frame member facing the first fenestration frame member; and
a mull connector having a first engagement member with a beveled terminal portion guiding the first engagement member onto a flange of the first frame member and a second engagement member with a beveled terminal end guiding the second engagement member onto a second flange of the second frame member.

17. The mulled fenestration assembly of claim 16, further including an end cap including a body operatively secured to a first end of the mull connector and including a channel extending about a front portion of the body of the end cap.

18. The mulled fenestration assembly of claim 17, wherein the end cap includes an aperture extending into the end cap and being in in fluid communication with the channel.

19. A method of sealing an end cap on a mulled fenestration assembly comprising:
providing a first fenestration frame;
providing a second fenestration frame;
securing a mull connector having a first end and a second end to the first fenestration frame and a second fenestration frame;
securing a first end cap to the first end of the mull connector and a second end cap to the second end connector, wherein the end cap includes an aperture in fluid communication with a channel extending about a front portion of the end cap; and
applying sealant to the end cap through the aperture until the channel is completely filled with sealant.

20. The method of claim 19, further including providing a sealing cover over the end cap prior to applying adhesive to the end cap and continuing to apply sealant to the end cap until sealant is visible between the aperture and the sealing cover.
